(19) United States
(12) Patent Application Publication
(10) Pub. No.: US 2022/0271382 A1
(43) Pub. Date: Aug. 25, 2022

(54) END PLATE AND BATTERY MODULE

(71) Applicant: HONDA MOTOR CO., LTD., Tokyo (JP)

(72) Inventors: Shigemitsu AKUTSU, Saitama (JP); Shinji FUJIMOTO, Saitama (JP)

(21) Appl. No.: 17/577,026

(22) Filed: Jan. 17, 2022

(30) Foreign Application Priority Data
Feb. 19, 2021 (JP) 2021-025452

(51) Int. Cl. H01M 50/262; H01M 50/207

(52) U.S. Cl. CPC H01M 50/262; H01M 50/207

(57) ABSTRACT

A battery module in which surface pressure is made uniform within a surface of each of the stacked battery cells with a simple and compact configuration is provided. A battery module in which a stacked body of a plurality of battery cells is pinched and held by end plates (first end plate and second end plate) from both end sides in a stacking direction is provided. In each of the end plates, a facing surface facing the stacked body includes a protruding surface portion. In each of the end plates, an opposite surface on the opposite side of the facing surface may include a recessed surface portion.

This application is based on and claims the benefit of priority from Japanese Patent Application No. 2021-025452, filed on 19 Feb. 2021, the content of which is incorporated herein by reference.

### BACKGROUND OF THE INVENTION

### Field of the Invention

The present invention relates to an end plate for a battery module serving as a power source of a motor-driven vehicle or the like, and a battery module to which the end plate is applied.

### Related Art

In order to allow a battery module serving as a power source of a motor-driven vehicle or the like to function appropriately, it is necessary to apply pressure to stacked battery cells in the stacking direction to pressurize them. As a pressurizing method, there is a method in which end fixing members (end plates) are provided on both side end faces of a stacked body of battery cells, and by fastening them with a plurality of bolts or bolts and nuts, a surface pressure load is applied to the battery cells. In general, end fixing members have almost uniform section modulus between bolts, and the pressurizing surface is almost flat. In that case, when a predetermined bolt axial force is applied, the end fixing member is deformed in an arc shape, whereby the pressurizing surface becomes a recessed shape as viewed from the pressurized object. Therefore, the surface pressure applied to the stacked battery cells becomes nonuniform in the surface, whereby a predetermined performance cannot be exhibited.

Meanwhile, a technique of equalizing the surface pressure between stacked battery cells by giving deflection to plate-shaped end fixing members to suppress surface pressure of a high stacked body has been proposed (for example, see Patent Document 1).

Patent Document 1: Japanese Patent No. 4211561

### SUMMARY OF THE INVENTION

The battery module of Patent Document 1 has a large number of components because deflection is adjusted by using a holding means having a screw mechanism with respect to the end plates. Further, the thickness of the end plate is increased, so that a space is generated between the stacked battery cells or between the end plate and the battery cells. Therefore, the volume density of the battery is lowered.

The present invention has been made in view of the above-described situation. An object of the present invention is to provide a battery module in which the surface pressure within a surface of each stacked battery cell is equalized with an easy and compact configuration.

(1) An end plate, a plurality of the end plates (for example, a first end plate 4 and a second end plate 5 described below) pinching and holding a stacked body (for example, a stacked body 3 described below) of a plurality of battery cells constituting a battery module (for example, a battery module 1 described below) from both end sides in a stacking direction, wherein

in the end plate, a facing surface (for example, a facing surface S1 described below) facing the stacked body includes a protruding surface portion.

(2) The end plate according to (1) above, wherein an opposite surface on the opposite side of the facing surface includes a recessed surface portion (for example, an opposite surface S2 on the opposite side of the facing surface described below).

(3) The end plate according to (1) above, wherein the end plates are connected to each other with a plurality of connecting members (for example, connecting bolts 6 described below) that connect a plurality of pairs of pressure receiving portions each providing a pair between the end plates on both end sides, and a section modulus between the own two pressure receiving portions is small at an intermediate position between the pressure receiving portions and is large on the pressure receiving portion side.

(4) An end plate, a plurality of the end plates (for example, a first end plate 4a and a second end plate 5a described below) pinching and holding a stacked body (for example, a stacked body 3 described below) of a plurality of battery cells (for example, battery cells 2 described below) constituting a battery module (for example, a battery module 1a described below) from both end sides in a stacking direction, wherein the end plates are connected to each other with a plurality of connecting members (for example, connecting bolts 6 described below) that connect a plurality of pairs of pressure receiving portions (for example, pressure receiving portions 11, 12 described below) each providing a pair between the end plates on the both end sides, a facing surface (for example, a facing surface Sla described below) facing the stacked body includes a protruding surface portion, and the end plate includes a plurality of through holes (for example, H00, H11, . . . , H15, H16, (H00), H21, . . . , H25, H26) that penetrate inside of the end plate in a surface inward direction.

(5) The end plate according to (4) above, wherein the plurality of through holes are provided such that a section modulus between the two pressure receiving portions in one of the end plates is relatively large in a vicinity of the pressure receiving portion and is relatively small at a position away from the pressure receiving portion.

(6) The end plate according to (5) above, wherein among the plurality of through holes, a through hole located closer to a center position between the pressure receiving portions has a larger opening area and a through hole located closer to the pressure receiving portion has a smaller opening area.

(7) The end plate according to (5) above, wherein the plurality of through holes are provided in a truss shape in which a barrier rib between adjacent through holes is inclined relative to a width direction of the end plate.

(8) A battery module (for example, a battery module 1 described below) in which a stacked body of a plurality of battery cells is pinched and held by end plates (for example, a first end plate 4 and a second end plate 5 described below) from both end sides in a stacking direction, wherein in each of the end plates, a facing surface (for example, a facing surface S1 described below) facing the stacked body includes a protruding surface portion.

(9) The battery module according to (8) above, wherein in each of the end plates, an opposite surface on the opposite side of the facing surface (for example, an opposite surface S2 on the opposite side of the facing surface described below) includes a recessed surface portion.

(10) The battery module according to (8) above, further comprising a plurality of connecting members that connect a plurality of pairs of pressure receiving portions each providing a pair between both end plates with respect to the both end plates on the both end sides, and in each of the end plates, a section modulus between the own two pressure receiving portions is small at an intermediate position between the pressure receiving portions and is large on the pressure receiving portion side.

(11) A battery module in which a stacked body of a plurality of battery cells is pinched and held by end plates from both end sides in a stacking direction, the battery module comprising a plurality of connecting members that connect a plurality of pairs of pressure receiving portions each providing a pair between the both end plates with respect to the both end plates on the both end sides, each of the end plates including a plurality of through holes penetrating the inside of the end plate in a surface inward direction.

(12) The end plate according to (11) above, wherein the plurality of through holes are provided such that a section modulus between the two pressure receiving portions in one of the end plates becomes relatively large in a vicinity of the pressure receiving portion and becomes relatively small at a position away from the pressure receiving portion.

(13) The battery module according to (12) above, wherein among the plurality of through holes, a through hole located closer to a center position between the pressure receiving portions has a larger opening area and a through hole located closer to the pressure receiving portion has a smaller opening area.

(14) The battery module according to (12) above, wherein the plurality of through holes are provided in a truss shape in which a barrier rib between adjacent through holes is inclined relative to a width direction of the end plate.

In the end plate according to (1), since the facing surface facing the stacked body has a protruding surface portion, when the stacked body of the battery cells is pinched, the surface on the battery cell side becomes almost flat, and the surface pressure at the time of pinching can become uniform within the surfaces.

In the end plate according to (2), the facing surface facing the stacked body has a protruding surface portion, and the opposite surface on the opposite side of the facing surface facing the stacked body has a recessed surface portion. Therefore, the section modulus of the end plate is relatively smaller in the center portion in the surface than that in the surrounding portion, so that the surface on the battery cell side easily becomes almost flat.

In the end plate according to (3), the end plates are connected to each other with a plurality of connecting members connecting a plurality of pairs of the pressure receiving portions each providing a pair between the end plates on both end sides, and the section modulus between the own two pressure receiving portions is small in the intermediate position between the pressure receiving portions and is large on the pressure receiving portion side. Therefore, since it is easy to make the change in the section modulus in the end plate continuous, the surface on the battery cell side is easily allowed to become almost flat. That is, the surface pressure in the surface of the battery cell becomes uniform more easily. In addition, since there is no need to increase the number of components so that the thickness of the end plate is not increased, size reduction can be realized.

The end plate according to (4) includes a plurality of through holes penetrating the inside of the end plate in the surface inward direction. Therefore, it is possible to change the section modulus in a pseudo continuous manner by lightening provided by the through holes to thereby allow the surface on the battery cell side to become almost flat easily.

Further, weight reduction can be realized by lightening. In addition, since there is no need to increase the number of components so that the thickness of the end plate is not increased, size reduction can be realized. Further, the opposite side of the surface on the battery cell side that is a pressurizing surface can be made into a flat surface, so that it is easy to be handled for mounting of other elements and components and the like.

In the end plate according to (5), the plurality of through holes are provided such that the section modulus between the two pressure receiving portions in one of the end plates becomes relatively large in the vicinity of the pressure receiving portions and becomes relatively small in a portion away from the pressure receiving portions. Therefore, it is possible to allow the surface on the battery cell side to be almost flat easily. That is, the surface pressure in the surface of the battery cell becomes uniform more easily. In addition, since there is no need to increase the number of components so that the thickness of the end plate is not increased, size reduction can be realized.

In the end plate according to (6), the section modulus in the end plat can be smaller in a pseudo continuous manner as it is closer to the center position between the pressure receiving portions. Accordingly, the surface pressure in the surface of the battery cell becomes uniform more easily.

In the end plate according to (7), the section modulus in the end plat can be smaller in a pseudo continuous manner as it is closer to the center position between the pressure receiving portions. Accordingly, the surface pressure in the surface of the battery cell becomes uniform more easily.

In the battery module according to (8), since the facing surface facing the stacked body includes a protruding surface portion, when the stacked body of the battery cells is pinched, the surface on the battery cell side become almost flat, and the surface pressure when pinching can become uniform within the surface.

In the battery module according to (9), in the end plate, the facing surface facing the stacked body has a protruding surface portion, and the opposite surface on the opposite side of the facing surface facing the stacked body has a recessed surface portion. Therefore, the section modulus of the end plate is relatively smaller in the center portion in the surface than that in the surrounding portion, so that the surface on the battery cell side easily becomes almost flat.

In the battery module according to (10), the battery module includes a plurality of connecting members connecting a plurality of pairs of the pressure receiving portions each providing a pair between both end plates with respect to the both end plates on the both end sides of the stacked body, and the section modulus between the own two pressure receiving portions is small in the intermediate position between the pressure receiving portions and is large on the pressure receiving portion side. Therefore, since it is easy to make the change in the section modulus in the end plate continuous, the surface on the battery cell side is easily allowed to become almost flat. That is, the surface pressure in the surface of the battery cell becomes uniform more easily. In addition, since there is no need to increase the number of components so that the thickness of the end plate is not increased, size reduction can be realized.

In the battery module according to (11), the end plate includes a plurality of through holes penetrating the inside of the end plate in a surface inward direction. Therefore, it is possible to change the section modulus in a pseudo continuous manner by lightening provided by the through holes to thereby allow the surface on the battery cell side to become almost flat easily. Further, weight reduction can be realized by lightening. In addition, since there is no need to increase the number of components so that the thickness of the end plate is not increased, size reduction can be realized. Further, the opposite side of the surface on the battery cell side that is a pressurizing surface can be made into a flat surface, so that it is easy to be handled for mounting of other elements and components and the like.

In the battery module according to (12), the plurality of through holes are provided such that the section modulus between the two pressure receiving portions in one of the end plates becomes relatively large in the vicinity of the pressure receiving portions and becomes relatively small in a portion away from the pressure receiving portions. Therefore, it is possible to allow the surface on the battery cell side to be almost flat easily. That is, the surface pressure in the surface of the battery cell becomes uniform more easily. In addition, since there is no need to increase the number of components so that the thickness of the end plate is not increased, size reduction can be realized.

In the battery module according to (13), the section modulus of the end plat can be smaller in a pseudo continuous manner as it is closer to the center position between the pressure receiving portions. Accordingly, the surface pressure in the surface of the battery cell becomes uniform more easily.

In the battery module according to (14), the section modulus of the end plat can be smaller in a pseudo continuous manner as it is closer to the center position between the pressure receiving portions. Accordingly, the surface pressure in the surface of the battery cell becomes uniform more easily.

### BRIEF DESCRIPTION OF THE DRAWINGS

FIG. 1 is a plan view of a battery module according to a first embodiment of the present invention;

FIG. 2 is a side view of the battery module of FIG. 1;

FIG. 3 illustrates the battery module of FIG. 1 as viewed from one end plate side;

FIG. 4 illustrates the battery module of FIG. 1 as viewed from the other end plate side;

FIG. 5 illustrates one end plate of the battery module of FIG. 1 alone;

FIG. 6 illustrates distribution of surface pressure of the end plate illustrated in FIG. 5 during pressurization;

FIG. 7 illustrates distribution of surface pressure of the end plate illustrated in FIG. 5 when pressurization is completed;

FIG. 8 is a plan view of a battery module according to a second embodiment of the present invention;

FIG. 9 is a side view of the battery module of FIG. 8;

FIG. 10 illustrates the battery module of FIG. 8 as viewed from one end plate side; and

FIG. 11 illustrates the battery module of FIG. 8 as viewed from the other end plate side.

### DETAILED DESCRIPTION OF THE INVENTION

### First Embodiment

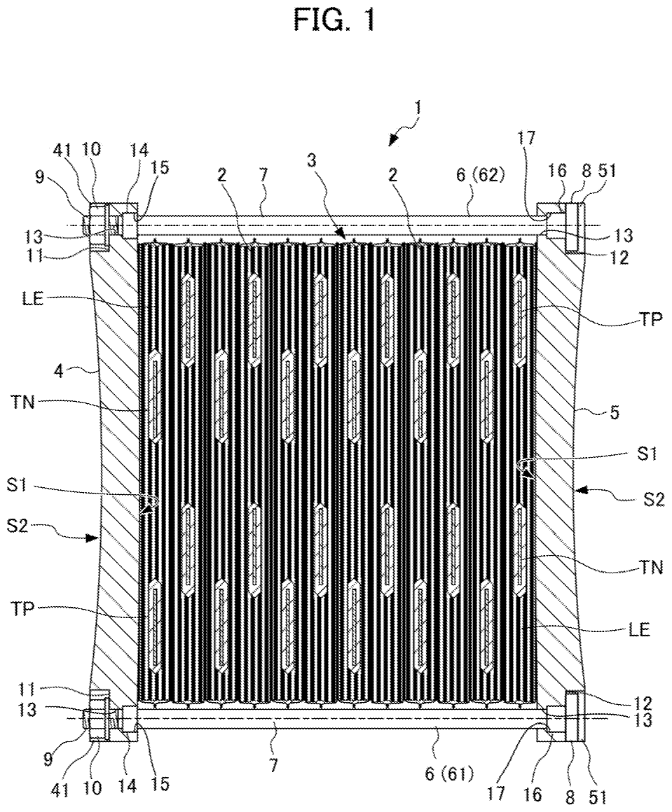

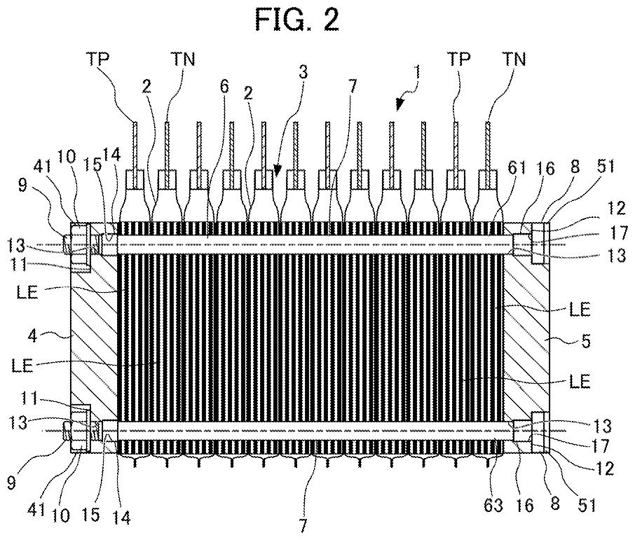

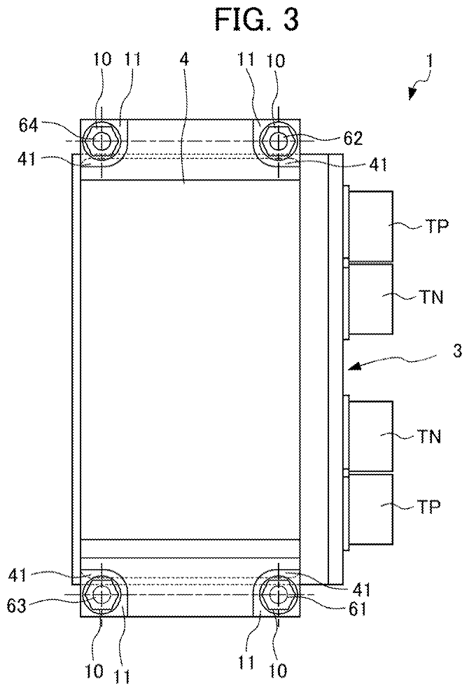

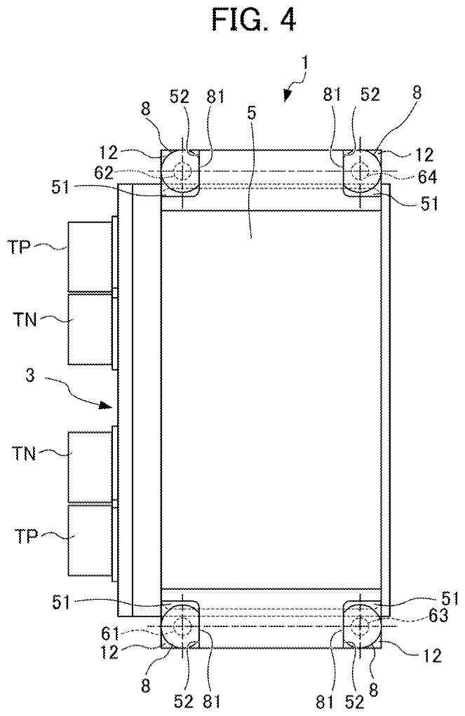

Hereinafter, a first embodiment of the present invention will be described with reference to the drawings. In the drawings shown below, the same components and corresponding components are denoted by the same reference numeral. FIG. 1 is a plan view of a battery module according to a first embodiment of the present invention, FIG. 2 is a side view of the battery module of FIG. 1, FIG. 3 illustrates the battery module of FIG. 1 as viewed from one end plate side, and FIG. 4 illustrates the battery module of FIG. 1 as viewed from the other end plate side.

A battery module 1 of the first embodiment is configured such that a stacked body 3 of a plurality of battery cells 2 in a flat shape that is, for example, a stacked body of laminate pack lithium-ion battery cells is pinched and held by a first end plate 4 and a second end plate 5 from both end sides in the stacking direction. Each battery cell 2 is configured such that a laminated electrodes LE are packed with a laminate sheet, and a positive terminal (positive tab) TP and a negative terminal (negative tab) TN are led out via a predetermined intra-cell connection. The battery cells 2 constitute the stacked body 3 in such a manner that a cell of one type in which a pair of terminals of a positive tab TP and a negative tab TN are arranged closer to the right end side and a cell of another type in which a pair of terminals thereof are arranged inversely and arranged closer to the left end side are alternately stacked. The first end plate 4 and the second end plate 5 are fastened in a direction of reducing the gap between the two end plates 4 and 5 with four connecting bolts 6 that are connecting members. Regarding the first end plate 4 and the second end plate 5, a facing surface that faces the stacked body 3 is denoted by a reference sign S1, and an opposite surface that is on the opposite side of the facing surface S1 is denoted by a reference sign S2. As described below, the facing surface S1 facing the stacked body 3 has a protruding surface portion, and the opposite surface on the opposite side of the facing surface S1 has a recessed surface portion.

The connecting bolt 6 includes a shaft portion 7 constituting the body, a head portion 8 provided on one end side of the shaft portion 7, and a male threaded portion 9 provided on the other end side of the shaft portion 7, and a nut 10 is screwed to the male threaded portion 9. On the other hand, the first end plate 4 has a pressure receiving portion 11 that is in surface contact with the nut 10 and receives the pressing force from the nut 10. Further, the second end plate 5 has a pressure receiving portion 12 that is in surface contact with the head portion 8 of the connecting bolt 6 and receives the pressing force from the nut 10. The pressure receiving portion 11 of the first end plate 4 and the pressure receiving portion 12 of the second end plate 5 are located at both end sides of one connecting bolt 6 and form a pair. Four pairs of the pressure receiving portion 11 and the pressure receiving portion 12 are provided corresponding to the four connecting bolts 6. That is, the four connecting bolts 6 connect a plurality of pairs (four pairs) of the pressure receiving portions 11 and 12 between the first end plate 4 and the second end plate 5.

In detail, as illustrated in FIGS. 1 to 4, the four connecting bolts 6 are a first connecting bolt 61, a second connecting bolt 62, a third connecting bolt 63, and a fourth connecting bolt 64. Here, when an attention is paid to the surroundings of the first connecting bolt 61, the pressing force from the nut 10 screwed to the male threaded portion 9 acts on the pressure receiving portion 11 of the first end plate 4. Note that in a fastened state, each nut 10 is housed in a recessed portion 41 provided in a thickness direction at each of the four corners of the opposite surface S2 on the opposite side of the facing surface S1 facing the stacked body 3 of the first end plate 4.

Further, the pressing force from the head portion 8 acts on the pressure receiving portion 12 of the second end plate 5. The first end plate 4 and the second end plate 5 each have four insertion holes 13 for allowing the four connecting bolts 6 to be inserted. In a portion of the connecting bolt 6 to be inserted into the insertion hole 13 in the vicinity of the position where the nut 10 is screwed to the male threaded portion 9, a nut-side large diameter portion 14 having a larger diameter than those of the male threaded portion 9 and the shaft portion 7 is provided coaxially. The nut-side large diameter portion 14 is closely fitted with a nut-side spigot portion 15 provided on the insertion hole 13, whereby the connecting bolt 6 is centered on the nut 10 side.

Further, in a portion continuing to the head portion 8 of the connecting bolt 6 to be inserted into the insertion hole 13, a head-side large diameter portion 16 having a larger diameter than that of the shaft portion 7 is provided coaxially. The head-side large diameter portion 16 is closely fitted with a head-side spigot portion 17 provided on the insertion hole 13, whereby the connecting bolt 6 is centered on the head portion 3 side.

Meanwhile, the head portion 8 of each of the first connecting bolt 61, the second connecting bolt 62, the third connecting bolt 63, and the fourth connecting bolt 64 is in a substantially disk shape, and has a cutout portion 81 for detent, visually recognized in FIG. 4, provided on a part of the outer periphery thereof. Each cutout portion 81 contacts a contact surface 52 of the recessed portion 51 provided in a thickness direction at each of the four corners of the opposite surface S2 on the opposite side of the facing surface S1 facing the stacked body 3 of the second end plate 5, whereby displacement around the shaft is regulated.

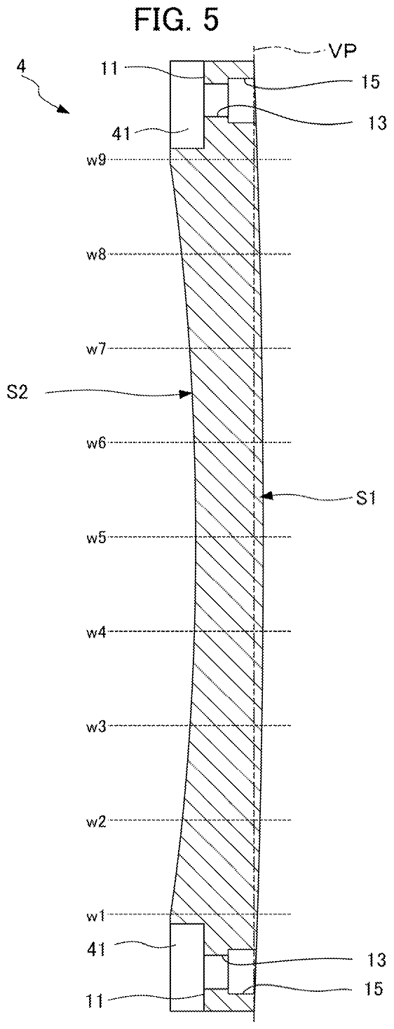

FIG. 5 illustrates the first end plate 4 of the battery module 1 in FIG. 1 alone. In FIG. 5, the first end plate 4 is illustrated alone by being enlarged from the same viewpoint as that of FIG. 1. On both end sides in the width direction of the first end plate 4, the insertion hole 13, the nut-side spigot portion 15, the recessed portion 41, and the pressure receiving portion 11, described with reference to FIG. 1, are provided. As illustrated, the center of the pressure receiving portion 11 matches the shaft center of the connecting bolt 6 passing through the insertion hole 13. Regarding the positions in the width direction of the first end plate 4, the center position from the right end side (the lower pressure receiving portion 11 side in FIG. 5) to the left end side (the upper pressure receiving portion 11 side in FIG. 5) is denoted by a reference sign w5, and the positions therefrom toward the right end side (lower side in FIG. 5) are denoted by reference signs w4, w3, w2, and w1 at equal intervals. Similarly, the positions from w5 toward the left end side (upper side in FIG. 5) are denoted by reference signs w6, w7, w8, and w9 at equal intervals.

In the first end plate 4, the facing surface S1 facing the stacked body 3 has a protruding surface portion. In the example of FIG. 5, the almost entire surface of the facing surface S1 forms a protruding surface toward the contact direction with the stacked body 3. That is, with respect to a virtual plane VP passing through the both ends of the facing surface S1 facing the stacked body 3, the separation width of the facing surface S1 becomes maximum at the center position w5. In detail, the facing surface S1 of the first end plate 4 has a curved surface that is gradually separated from the virtual plane VP toward the contact direction with the stacked body 3 from the position w1 toward the positions w2, w3, w4, and w5, and the separation width from the virtual plane VP becomes maximum at the center position w5, and the separation width is gradually reduced from the center position w5 toward the positions w6, w7, w8, and w9.

On the other hand, the opposite surface S2 that is on the opposite side of the facing surface S1 facing the stacked body 3 of the first end plate 4 has a recessed surface portion. In the example of FIG. 5, the almost entire surface of the opposite surface S2 on the opposite side of the facing surface S1 forms a recessed surface toward the contact direction with the stacked body 3. In detail, the surface S2 of the first end plate 4 has a curved surface that is gradually recessed toward the contact direction with the stacked body 3 from the position w1 toward the positions w2, w3, w4, and w5, and the depth of the recess becomes maximum at the center position w5, and the depth of the recess is gradually decreased from the center position w5 toward the positions w6, w7, w8, and w9.

Regarding the first end plate 4 having the above-described shape, the characteristics thereof will be described from the viewpoint of section modulus (bending rigidity). The section modulus of the first end plate 4 shows a tendency of being gradually reduced from the position w1 toward the positions w2, w3, w4, and w5, becomes minimum at the center position w5, is gradually increased from the center position w5 toward the positions w6, w7, w8, and w9, and at the position w9, becomes almost the same as the section modulus at the position w1. That is, in the first end plate 4, the section modulus between the right and left two pressure receiving portions 11 and 11 is small at the position w5 that is the intermediate position between the two pressure receiving portions 11 and 11, and is large on the two pressure receiving portions 11 and 11 sides (positions w1 and w9 sides).

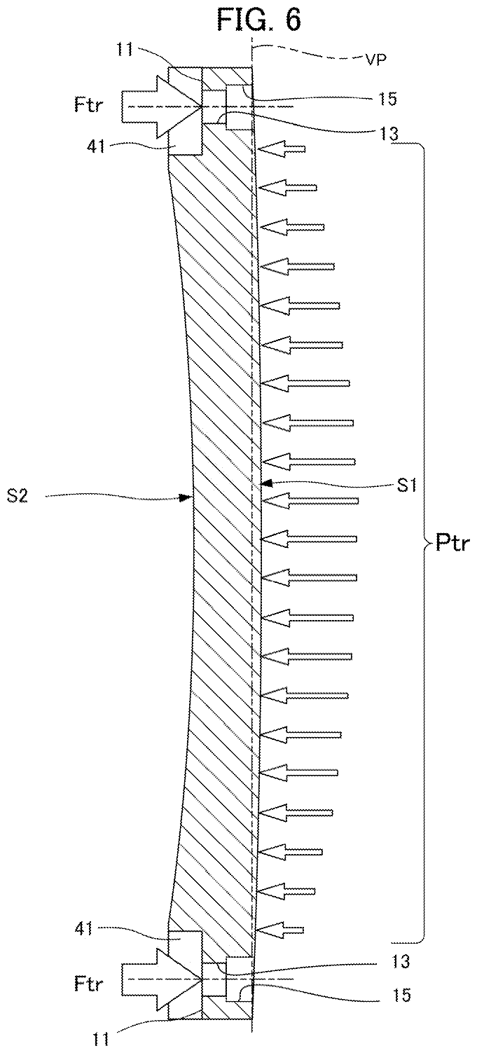

FIG. 6 illustrates distribution of surface pressure of the first end plate 4 described with reference to FIG. 5 during pressurization. In the drawing, the direction of each arrow indicates the direction in which the surface pressure acts from the stacked body 3 to the facing surface S1, and the length indicates the magnitude of the surface pressure at the position of the arrow. A value obtained by applying surface integral to the surface pressure Ptr at each position (fine unit area) throughout the entire surface represents the entire pressure to the facing surface S1. This phenomenon is similar in the case of the second end plate 5. That is, the first end plate 4 and the second end plate 5 pinch and hold the stacked body 3 with the four connecting bolts 6 to thereby generate the entire pressure. Accordingly, assuming that the axial force of one connecting bolt 6 is represented by Ftr, the force as large as the number thereof (four times) equals to the entire pressure. In the stage during pressurization as shown in FIG. 6, the surface pressure at each portion within the surface of the facing surface S1 shows a tendency as described below, when focusing on each position assumed in FIG. 5. That is, the surface pressure per fine unit area shows a tendency that it is gradually increased from the position w1 toward the positions w2, w3, w4, and w5, becomes maximum at the center position w5, and is gradually decreased from the center position w5 toward the positions w6, w7, w8, and w9, and the surface pressure per fine unit area at the position w9 is almost equal to the value at the position w1. That is, the surface pressure in each portion within the surface of the facing surface S1 is not uniform throughout the surface, and shows distribution in which the surface pressure differs depending on the position such that it is large at the center of the facing surface S1 that is a protruding surface and is small in the surroundings. Therefore, in the state of FIG. 6, each battery cell 2 constituting the stacked body 3 cannot exhibit sufficient performance. From this state, the respective nuts 10 of the four connecting bolts 6 are further fastened to increase the axial force of the connecting bolts 6. Then, the facing surface S1 that is a protruding surface at the beginning of fastening easily warps and becomes closer to a flat surface as it approaches the center position w5, according to the distribution of the section modulus described with reference to FIG. 5.

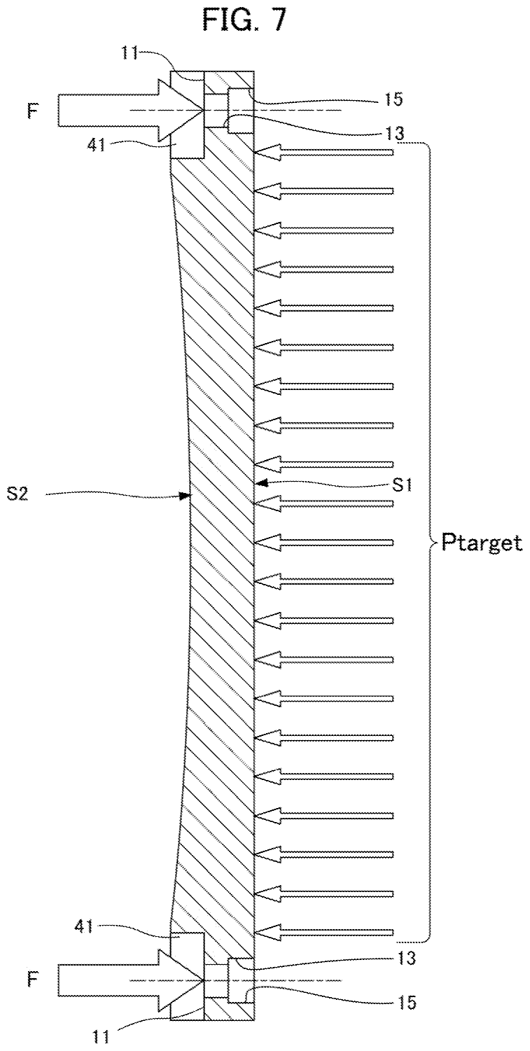

FIG. 7 illustrates distribution of surface pressure of the first end plate 4 described with reference to FIG. 5 when pressurization is completed. Similar to the case of FIG. 6, the direction of each arrow indicates the direction in which the surface pressure acts from the stacked body 3 to the facing surface S1, and the length indicates the magnitude of the surface pressure at the position of the arrow. In the stage during pressurization of FIG. 6, the surface pressure in each portion within the surface of the facing surface S1 shows distribution in which the surface pressure is large at the center of the facing surface S1 that is a protruding surface and is small in the surroundings, and is not uniform throughout the entire surface. From this stage, when each nut 10 of the four connecting bolts 6 is further fastened and the axial force of the connecting bolt 6 is increased, the facing surface S1 of the first end plate 4 easily warp as it approaches the center position w5 according to the distribution of the section modulus described with reference to FIG. 5, and becomes a flat surface almost completely as illustrated in FIG. 7. The axial force of each of the four connecting bolts 6 in this case becomes an axial force Ftarget that is larger than Ftr in the stage of FIG. 5. Further, the surface pressure at each position (fine unit area) within the surface of the facing surface 51 becomes a target value Ptarget in the specification that is uniform throughout the surface of the facing surface S1 that is a flat surface almost completely. Accordingly, a value obtained by simply multiplying the value Ptarget by the area of the facing surface S1 is the entire pressure. The entire pressure is equal to the number of times (four times) as large as the axial force F of one connecting bolt 6. In the state shown in FIG. 7, the surface pressure within the surface of the facing surface S1 becomes the target value Ptarget that is uniform throughout the entire surface. Therefore, the surface pressure within the surface of each battery cell 2 constituting the stacked body 3 becomes uniform, and the battery module can exhibit sufficient performance.

While the structure and the dynamic characteristics of the first end plate 4 have been described with reference to FIGS. 5 to 7, the structure and the dynamic characteristics of the second end plate 5 also have a configuration similar that described above for the first end plate 4.

### Second Embodiment

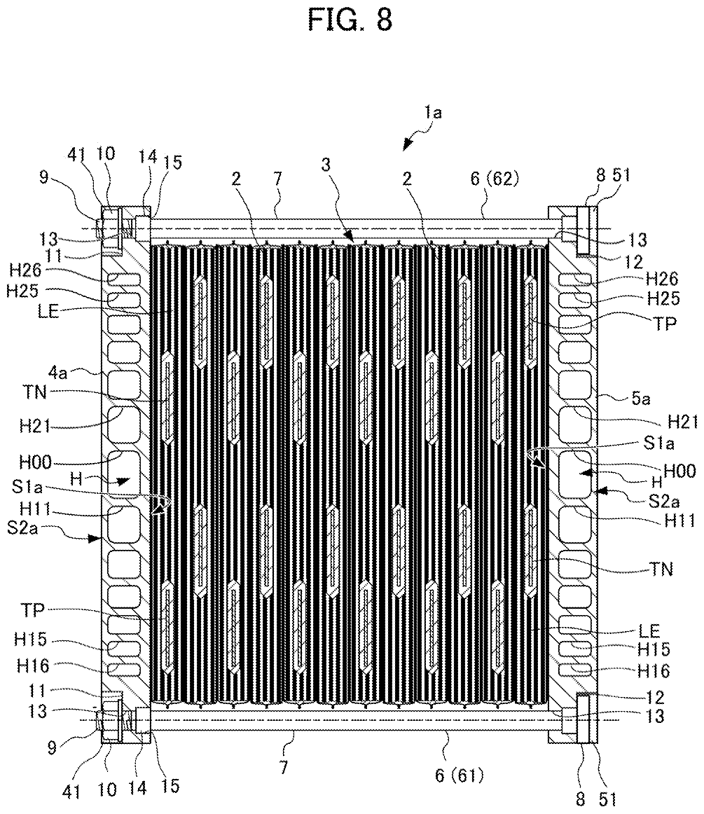

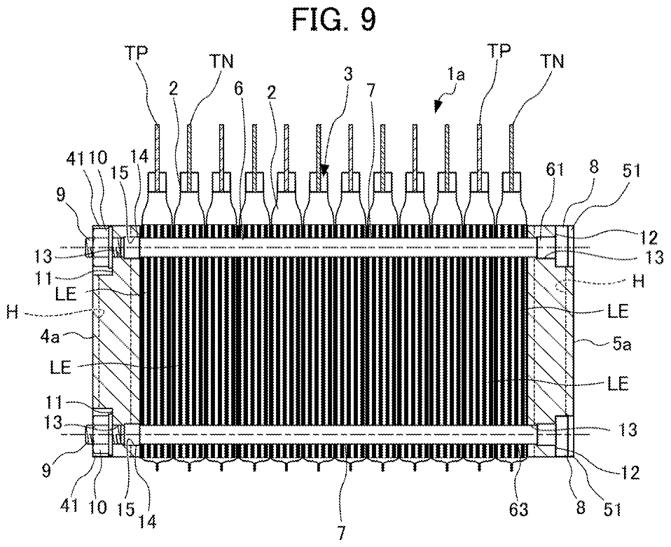

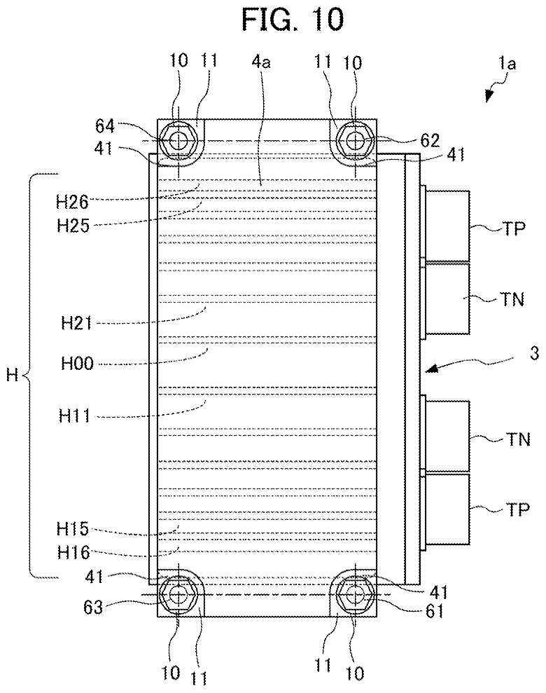

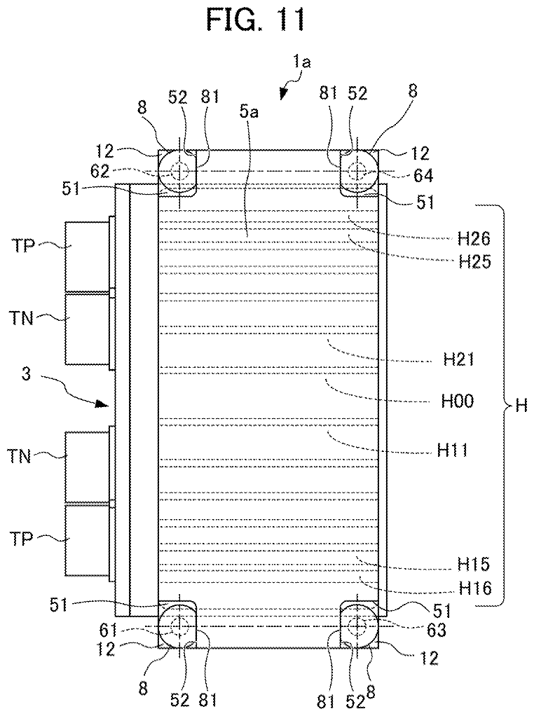

Next, a second embodiment of the present invention will be described with reference to the drawings. In the drawings shown below, the same components and corresponding components are denoted by the same reference numeral. FIG. 8 is a plan view of a battery module according to a second embodiment of the present invention, FIG. 9 is a side view of the battery module of FIG. 8, FIG. 10 illustrates the battery module of FIG. 8 as viewed from one end plate side, and FIG. 11 illustrates the battery module of FIG. 8 as viewed from the other end plate side.

A battery module 1a of the second embodiment is configured such that a stacked body 3 of a plurality of battery cells 2 that is a stacked body of laminate pack lithium-ion battery cells, for example, is pinched and held by a first end plate 4a and a second end plate 5a from both end sides in the stacking direction. Each battery cell 2 is configured such that a laminated electrodes LE are packed with a laminate sheet, and a positive terminal (positive tab) TP and a negative terminal (negative tab) TN are led out via a predetermined intra-cell connection. The battery cells 2 constitute the stacked body 3 in such a manner that a battery cell of one type in which a pair of terminals of a positive tab TP and a negative tab TN are arranged closer to the right end side and a battery cell of another type in which a pair of such terminals are arranged closer to the left end side. The first end plate 4a and the second end plate 5a are fastened in a direction of reducing the gap between the two end plates 4a and 5a with four connecting bolts 6 that are connecting members. Regarding the first end plate 4a and the second end plate 5a, a facing surface that faces the stacked body 3 is denoted by a reference sign Sla, and an opposite surface that is on the opposite side of the facing surface Sla is denoted by a reference sign S2a.

The connecting bolt 6 includes a shaft portion 7 constituting the body, a head portion 8 provided on one end side of the shaft portion 7, and a male threaded portion 9 provided on the other end side of the shaft portion 7, and a nut 10 is screwed to the male threaded portion 9. On the other hand, the first end plate 4a has a pressure receiving portion 11 that is in surface contact with the nut 10 and receives the pressing force from the nut 10. Further, the second end plate 5a has a pressure receiving portion 12 that is in surface contact with the head portion 8 of the connecting bolt 6 and receives the pressing force from the nut 10. The pressure receiving portion 11 of the first end plate 4a and the pressure receiving portion 12 of the second end plate 5a are located at both end sides of one connecting bolt 6, and form a pair. Four pairs of the pressure receiving portion 11 and the pressure receiving portion 12 are provided corresponding to the four connecting bolts 6. That is, the four connecting bolts 6 connect a plurality of pairs (four pairs) of the pressure receiving portions 11 and 12 between the first end plate 4a and the second end plate 5a.

In detail, as illustrated in FIGS. 8 to 11, the four connecting bolts 6 are a first connecting bolt 61, a second connecting bolt 62, a third connecting bolt 63, and a fourth connecting bolt 64. Here, when an attention is paid to the surroundings of the first connecting bolt 61, the pressing force from the nut 10 screwed to the male threaded portion 9 acts on the pressure receiving portion 11 of the first end plate 4a. Note that each nut 10 is housed in a recessed portion 41 provided in a thickness direction at each of the four corners of the opposite surface S2a on the opposite side of the facing surface Sla facing the stacked body 3 of the first end plate 4a, in the fastened state.

Further, the pressing force from the head portion 8 acts on the pressure receiving portion 12 of the second end plate 5a. The first end plate 4a and the second end plate 5a each have four insertion holes 13 for allowing the four connecting bolts 6 to be inserted. In a portion of the connecting bolt 6 to be inserted into the insertion hole 13 in the vicinity of the position where the nut 10 is screwed to the male threaded portion 9, a nut-side large diameter portion 14 having a larger diameter than those of the male threaded portion 9 and the shaft portion 7 is provided coaxially. The nut-side large diameter portion 14 is closely fitted with a nut-side spigot portion 15 provided on the insertion hole 13, whereby the connecting bolt 6 is centered on the nut 10 side.

Meanwhile, the head portion 8 of each of the first connecting bolt 61, the second connecting bolt 62, the third connecting bolt 63, and the fourth connecting bolt 64 is in a substantially disk shape, and has a cutout portion 81 for detent, visually recognized in FIG. 11, provided on a part of the outer periphery thereof. Each cutout portion 81 contacts a contact surface 52 of the recessed portion 51 provided in a thickness direction at each of the four corners of the opposite surface S2a on the opposite side of the facing surface Sla facing the stacked body 3 of the second end plate 5a, whereby displacement around the shaft is regulated.

In the second embodiment of the present invention illustrated in FIGS. 8 to 11, the forms of the first end plate 4a and the second end plate 5a differ from those of the first embodiment. Each of the first end plate 4a and the second end plate 5a has a plurality of through holes H penetrating inside thereof in the surface inward direction. The longitudinal direction of each through hole H is a surface inward direction and an up and down direction of the first end plate 4a and the second end plate 5a (direction connecting the side where the electrode TP or TN is provided of each battery cell 2 and the opposite side). That is, the longitudinal direction of each through hole H is a direction vertically intersecting the sheet surface in FIG. 8, is an up and down direction in FIG. 9, and is a left and right direction in FIGS. 10 and 11.

As illustrated, among the plurality of through holes H, a through hole 800 at the center position in the up and down direction of the first end plate 4a and the second end plate 5a has the largest opening area. Through holes H11, . . . , H15, and H16 sequentially provided at positions rightward (lower side in FIG. 8) from the through hole 800 at the center position are provided to have opening areas that are gradually reduced sequentially. Further, through holes H21, . . . , H25, and H26 sequentially provided at positions leftward (upper side in FIG. 8) from the through hole H00 at the center position are provided to have opening areas that are gradually reduced sequentially. Alternatively, it is possible to have a form in which a rib between through holes are not provided parallel to each other but are provided in an oblique truss shape such that the section modulus (section rigidity) is gradually reduced toward the center portion.

The first end plate 4a and the second end plate 5a are provided with the through holes 800, 811, . . . , H15, H16, (H00), H21, . . . , H25, and H26 as described above. Therefore, in the first end plate 4a, the section modulus between the two, left and right pressure receiving portions 11 and 11 is small at a portion where the through hole 800 is provided at the intermediate position between the two pressure receiving portions 11 and 11, and is large on the two pressure receiving portion sides (sides where the through hole H16 and the through hole H26 are provided). Similarly, in the second end plate 5a, the section modulus between the two, left and right pressure receiving portions 12 and 12 is small at a portion where the through hole H00 is provided at the intermediate position between the two pressure receiving portions 12 and 12, and is large on the two pressure receiving portion 12 and 12 sides (sides where the through hole H16 and the through hole H26 are provided). The section modulus of each of the first end plate 4a and the second end plate 5a varies in stages in a discontinuous manner between the left and right two pressure receiving portions. With the structure in which changes in stages of the opening areas of the through holes are gradually changed at a plurality of stages, it is also possible to have an end plate having a form in which the section modulus varies in a pseudo continuous manner. Since the first end plate 4a and the second end plate 5a have a structure in which the section modulus varies in stages or in a pseudo continuous manner, the surface pressure within the surface at the time of pinching and holding the stacked body 3 of the plurality of battery cells 2 takes a uniform value throughout the surface, as described with reference to FIGS. 6 and 7. Therefore, the surface pressure within the surface of each battery cell 2 constituting the stacked body 3 becomes uniform, and the battery module 1a can exhibit sufficient performance.

According to the end plate and the battery module of the present embodiment, the advantageous effects described below are exhibited.

(1) In the first end plate 4 and the second end plate 5, since the facing surfaces S1 facing the stacked body 3 each have a protruding surface portion, when the stacked body 3 of the battery cells 2 is pinched, the surfaces of the first end plate 4 and the second end plate 5 on the battery cell side become almost flat, and the surface pressure at the time of pinching can become uniform within the surfaces.

(2) The facing surface S1 facing the stacked body 3 has a protruding surface portion, and the opposite surface S2 on the opposite side of the facing surface S1 facing the stacked body has a recessed surface portion. Therefore, the section modulus of each of the first end plate 4 and the second end plate 5 is relatively smaller in the center portion in the surface than that in the surrounding portion, so that the surface on the battery cell 2 side easily becomes almost flat.

(3) The first end plate 4 and the second end plate 5 are connected to each other with a plurality of connecting bolts 6 connecting a plurality of pairs of the pressure receiving portions 11 and 12, and the section modulus between the own two pressure receiving portions 11 and 11 or 12 and 12 is small in the intermediate position between the pressure receiving portions and is large on the pressure receiving portion side. Therefore, since it is easy to make the change in the section modulus in each of the first end plate 4 and the second end plate 5 continuous, the surface on the battery cell 2 side is easily allowed to become almost flat. That is, the surface pressure in the surface of the battery cell 2 becomes uniform more easily. In addition, since there is no need to increase the number of components so that the thickness of each of the first end plate 4 and the second end plate 5 is not increased, size reduction can be realized.

The first end plate 4a and the second end plate 5a in each of which the facing surface Sla facing the stacked body 3 has a protruding surface portion, have a plurality of through holes H00, H11, H15, H16, H21, H25, and H26 penetrating the inside thereof in the surface inward direction. Therefore, it is possible to change the section modulus in a pseudo continuous manner by lightening provided by the through holes H00, H11, H15, H16, H421, H25, and H26, to allow the surface Sla on the battery cell 2 side almost flat easily. Further, weight reduction can be realized by lightening. In addition, since there is no need to increase the number of components so that the thickness of each of the first end plate 4a and the second end plate 5a is not increased, size reduction can be realized. Further, the opposite side of the surface on the battery cell 2 side that is a pressurizing surface can be made into a flat surface, so that it is easy to be handled for mounting of other elements and components and the like.

(5) In the first end plate 4a and the second end plate 5a, the plurality of through holes H00, H11, H15, H16, H21, H25, and H26 are provided such that the section modulus between the two pressure receiving portions 11 and 11 or 12 and 12 in the first end plate 4a (second end plate 5a) becomes relatively large in the vicinity of the pressure receiving portion and becomes relatively small in a portion away from the pressure receiving portion. Therefore, it is possible to allow the surface on the battery cell 2 side to be almost flat easily. That is, the surface pressure in the surface of the battery cell 2 becomes uniform more easily. In addition, since there is no need to increase the number of components so that the thickness of the end plate is not increased, size reduction can be realized.

(6) The through holes H00, H11, H15, H16, H21, H25, and H26 of the first end plate 4a and the second end plate 5a have a larger opening area as it is closer to the center position between the pressure receiving portions 11 and 11 or 12 and 12, and have a smaller opening area as it is closer to the pressure receiving portions 11 and 12. Therefore, the section modulus in the first end plate 4a and the second end plate 5a can be smaller in a pseudo continuous manner as it is closer to the center position between the pressure receiving portions 11 and 11 or 12 and 12. Accordingly, the surface pressure in the surface of the battery cell 2 becomes uniform more easily.

(7) The plurality of through holes in the first end plate and the second end plate are provided in a truss shape in which a barrier rib between adjacent holes is inclined relative to the width direction of the end plate. Therefore, the section modulus in the end plate can be smaller in a pseudo continuous manner as it is closer to the center position between the pressure receiving portions. Accordingly, the surface pressure in the surface of the battery cell becomes uniform more easily.

(2) In the battery module 1, the first end plate 4 and the second end plate 5 that pinch and hold the stacked body 3 of the plurality of battery cells 2 from the both end sides in the stacking direction each have the facing surface S1 facing the stacked body 3 having a protruding surface portion. Therefore, at the time of pinching the stacked body 3 of the battery cells 2 between them, the surfaces S1 of the first end plate 4 and the second end plate 5 on the battery cell 2 side become almost flat, and the surface pressure when pinching can be uniform within the surface.

(9) In the battery module 1, the first end plate 4 and the second end plate 5, the opposite surface S2 on the opposite side of the facing surface S1 facing the stacked body 3 has a recessed surface portion. Therefore, the section modulus of the first end plate 4 and the second end plate 5 tends to be smaller on the center side than the end side of the end plate. Accordingly, the first end plate 4 and the second end plate 5 each easily warp at a position closer to the center position w5 of the facing surface 31 facing the stacked body 3 corresponding to the distribution of the section modulus, and becomes almost completely flat in a state of pinching and holding the stacked body 3 from the both end sides in the stacking direction. As a result, the surface pressure of the facing surface S1 facing the stacked body 3 becomes uniform in the surface. Therefore, each battery cell 2 constituting the stacked body 3 can exhibit sufficient performance.

(10) The battery module 1 includes connecting bolts 6 (61, 62, 63, 64) that are a plurality of connecting members connecting a plurality of pairs of the pressure receiving portions 11-12 with respect to the first end plate 4 and the second end plate 5, and in the first end plate 4 and the second end plate 5, the section modulus between the own two pressure receiving portions 11 and 11 or 12 and 12 is small in the center position between the pressure receiving portions and is large on the pressure receiving portion side. Therefore, they easily warp at a position closer to the center position w5 of the facing surface S1 facing the stacked body 3 corresponding to the distribution of the section modulus, and become almost completely flat in a state of pinching and holding the stacked body 3 from the both end sides in the stacking direction. As a result, the surface pressure of the facing surface S1 facing the stacked body 3 becomes uniform in the surface. Consequently, each battery cell 2 constituting the stacked body 3 can exhibit sufficient performance.

(11) The battery module 1a includes connecting bolts 6 (61, 62, 63, 64) that are a plurality of connecting members connecting a plurality of pairs of the pressure receiving portions 11-12 providing a pair between both end plates with respect to the first end plate 4 and the second end plate 5 that pinch and hold the stacked body 3 of a plurality of battery cells 2 from both end sides in the stacking direction. In the first end plate 4 and the second end plate 5, the facing surface S1a facing the stacked body 3 has a protruding surface portion, and includes through holes H00, H11, . . . , H15, H16, (H00), H21, . . . , H25, and H26 that penetrate inside the own in the surface inward direction and whose size varies sequentially. Therefore, the first end plate 4 and the second end plate 5 each have a configuration that the section modulus becomes smaller on the center side than the end side. Accordingly, the surface pressure in the surface when the stacked body 3 of the plurality of battery cells 2 is pinched and held can be uniform throughout the surface. Thereby, each battery cell 2 constituting the stacked body 3 can exhibit sufficient performance.

(12) In the battery module 1a, the through holes H00, H11, . . . , H15, H16, (H00), H21, . . . , H25, and H26 are provided such that the section modulus between the two pressure receiving portions 11 and 11 or 12 and 12 in the first end plate 4a (second end plate 5a) becomes relatively large in the vicinity of the pressure receiving portion and becomes relatively small in a portion away from the pressure receiving portion. Therefore, the surface 51 on the battery cell 2 side can become almost flat easily. That is, the surface pressure in the surface of the battery cell 2 becomes uniform more easily. In addition, since there is no need to increase the number of components so that the thickness of the end plate is not increased, size reduction can be realized.

(13) In the battery module 1a, the plurality of through holes H00, H11, . . . , H15, H16, (H00), H21, . . . , H25, and H26 of the first end plate 4a and the second end plate 5a have a larger opening area as it is closer to the center position between the pairs of pressure receiving portions 11-12, and have a smaller opening area as it is closer to the pressure receiving portions 11 and 12. Accordingly, the surface pressure in the surface of the battery cell becomes uniform more easily.

(14) In the battery module 1a, the plurality of through holes H00, H11, . . . , H15, H16, (H00), H21, . . . , H25, and H26 are provided in a truss shape in which a barrier rib between adjacent holes is inclined relative to the width direction of the first end plate 4a (second end plate 5a). Therefore, the section modulus in the first end plate 4a (second end plate 5a) can be smaller in a pseudo continuous manner as it is closer to the center position between the pressure receiving portions. Accordingly, the surface pressure in the surface of the battery cell 2 becomes uniform more easily.

While embodiments of the present invention have been described, the present invention is not limited thereto. The details of the configuration can be changed as appropriate within the effect of the present invention. For example, in the examples of the first exemplary embodiment and the second embodiment, in order to pressurize and hold a stacked body of a plurality of battery cells by end plates from the both end sides in the stacking direction, a configuration in which both end plates are connected using connecting bolts as a connecting member is adopted. However, the connecting member is not limited to a connecting bolt. A configuration using a plate-shaped longitudinal member can also be adopted.

Further, in the second embodiment, as both end plates, those having a plurality of through holes penetrating the inside thereof in the surface inward direction are applied. Instead, it is also possible to apply a member in which an extruded material or a drawn material or members made of different material are stacked and the section modulus thereof is changed like the end plate having the above-described aspect. Even in that case, the section modulus may be changed in stages in a discontinuous manner or may be changed in a pseudo continuous manner.

### EXPLANATION OF REFERENCE NUMERALS

1, 1a battery module
2 battery cell
3 stacked body
4 first end plate
5 second end plate
6 connecting bolt
7 shaft portion
8 head portion
9 male threaded portion
10 nut
11, 12 pressure receiving portion
13 insertion hole
14 nut-side large diameter portion
15 nut-side spigot portion
16 head-side large diameter portion
17 head-side spigot portion
41 recessed portion
51 recessed portion
52 contact surface
61 first connecting bolt
62 second connecting bolt
63 third connecting bolt
64 fourth connecting bolt
81 cutout portion
H8, H11, H15, H16, H21, H25, H26 through hole
S1, S1a facing surface facing a stacked body
S2, S2a opposite surface on the opposite side of facing surface

What is claimed is:

1. An end plate, a plurality of the end plates pinching and holding a stacked body of a plurality of battery cells constituting a battery module from both end sides in a stacking direction, the end plate comprising;
a facing surface facing the stacked body, the facing surface including a protruding surface portion.

2. The end plate according to claim 1, further comprising an opposite surface on an opposite side of the facing surface, wherein the opposite surface includes a recessed surface portion.

3. The end plate according to claim 1, wherein
the end plates are connected to each other with a plurality of connecting members that connect a plurality of pairs of pressure receiving portions each providing a pair between the end plates on the both end sides, and a section modulus between own two pressure receiving portions is small at an intermediate position between the pressure receiving portions and is large on the pressure receiving portion side.

4. An end plate, a plurality of the end plates pinching and holding a stacked body of a plurality of battery cells constituting a battery module from both end sides in a stacking direction, wherein
the end plates are connected to each other with a plurality of connecting members that connect a plurality of pairs of pressure receiving portions each providing a pair between the end plates on the both end sides, a facing surface facing the stacked body includes a protruding surface portion, and the end plate includes a plurality of through holes that penetrate inside of the end plate in a surface inward direction.

5. The end plate according to claim 4, wherein
the plurality of through holes are provided such that a section modulus between the two pressure receiving portions in one of the end plates is relatively large in a vicinity of the pressure receiving portion and is relatively small at a position away from the pressure receiving portion.

6. The end plate according to claim 5, wherein
among the plurality of through holes, a through hole located closer to a center position between the pressure receiving portions has a larger opening area and a through hole located closer to the pressure receiving portion has a smaller opening area.

7. The end plate according to claim 5, wherein
the plurality of through holes are provided in a truss shape in which a barrier rib between adjacent through holes is inclined relative to a width direction of the end plate.

8. A battery module comprising end plates, the end plates pinching and holding a stacked body of a plurality of battery cells from both end sides in a stacking direction, wherein
each of the end plates including a facing surface facing the stacked body, the facing surface including a protruding surface portion.

9. The battery module according to claim 8, wherein
in each of the end plates, an opposite surface on an opposite side of the facing surface includes a recessed surface portion.

10. The battery module according to claim 8, further comprising a plurality of connecting members that connect a plurality of pairs of pressure receiving portions each providing a pair between both end plates with respect to the both end plates on the both end sides, and
in each of the end plates, a section modulus between own two pressure receiving portions is small at an intermediate position between the pressure receiving portions and is large on the pressure receiving portion side.

11. A battery module comprising end plates, the end plates pinching and holding a stacked body of a plurality of battery cells from both end sides in a stacking direction, wherein
the battery module further comprising a plurality of connecting members that connect a plurality of pairs of pressure receiving portions each providing a pair between both end plates with respect to the both end plates on the both end sides, and wherein
each of the end plates including a facing surface facing the stacked body, the facing surface including a protruding surface portion, each of the end plates including a plurality of through holes penetrating inside of the end plate in a surface inward direction.

12. The battery module according to claim 11, wherein
the plurality of through holes are provided such that a section modulus between the two pressure receiving portions in one of the end plates becomes relatively large in a vicinity of the pressure receiving portion and becomes relatively small at a position away from the pressure receiving portion.

13. The battery module according to claim 12, wherein
among the plurality of through holes, a through hole located closer to a center position between the pressure receiving portions has a larger opening area and a through hole located close to the pressure receiving portion has a smaller opening area.

14. The battery module according to claim 12, wherein
the plurality of through holes are provided in a truss shape in which a barrier rib between adjacent through holes is inclined relative to a width direction of the end plate.

15. The end plate according to claim 2, wherein
the end plates are connected to each other with a plurality of connecting members that connect a plurality of pairs of pressure receiving portions each providing a pair between the end plates on the both end sides, and a section modulus between own two pressure receiving portions is small at an intermediate position between the pressure receiving portions and is large on the pressure receiving portion side.

16. The battery module according to claim 9, further comprising a plurality of connecting members that connect a plurality of pairs of pressure receiving portions each providing a pair between both end plates with respect to the both end plates on the both end sides, and
in each of the end plates, a section modulus between own two pressure receiving portions is small at an intermediate position between the pressure receiving portions and is large on the pressure receiving portion side.
